(19) United States
(12) Patent Application Publication
(10) Pub. No.: US 2023/0013294 A1
(43) Pub. Date: Jan. 19, 2023

(54) COMPUTER-IMPLEMENTED METHOD FOR DETERMINING A MERCHANT LOCATION USING A VIRTUAL CARD, IN REAL-TIME

(71) Applicant: Visa International Service Association, San Francisco, CA (US)

(72) Inventors: Neela Devi Natarajan, Bangalore, Karnataka (IN); Singara Velan Mohan Mareeswaran, Doddanekundi, Bangalore (IN); Yogesh Kumar, Marathahalli, Bangalore (IN)

(21) Appl. No.: 17/783,054

(22) PCT Filed: Dec. 9, 2019
(86) PCT No.: PCT/US2019/065152

§ 371 Date: Jun. 7, 2022

(51) Int. Cl. G06Q 20/40; G06Q 20/34; G06Q 20/38

(52) U.S. Cl. CPC G06Q 20/4014; G06Q 20/351; G06Q 20/3825; G06Q 20/389; G06Q 20/4015; G06Q 20/4016

(57) ABSTRACT

The present disclosure is related to a computer-implemented method, card processing server, and non-transitory computer readable medium for determining a merchant location using a virtual card, in real-time. A card processing server may receive test transaction data from an acquirer bank of a merchant when a test transaction is initiated through a virtual card provided to the merchant. The card processing server may detect a record of the test transaction in a transaction database, in real-time, using one or more attributes of the virtual card stored in the card processing server and may retrieve signature data from the test transaction data upon detecting the record of the test transaction. Finally, the card processing server determines a transaction source data location of the merchant at which the test transaction was initiated and a registered name of the merchant based on the signature data.

### BACKGROUND

### 1. Technical Field

The present disclosure relates to payment transactions. Particularly, but not exclusively, the present disclosure relates to a computer-implemented method for determining a merchant location using a virtual card, in real-time.

### 2. Technical Considerations

A large segment of population chooses to perform cashless transactions by using payment cards, such as a debit card or a credit card, which results in abundance of transaction data. Performing data analytics on such transaction data helps in various applications, such as peer detection, setting up loyalty offers and discounts, detection of fraud merchants, Merchant Category Code (MCC) fee compliance, transaction related dispute management, and the like. However, correct and reliable data analytics of the transaction data is possible only when the merchant details, such as name of the merchant, roof-top location of the merchant, address of the merchant, Card Acceptor Identifier (CAID) of the merchant, and the like, is clear from the transaction data. Each merchant store may have multiple branches at multiple locations and each location may have multiple remote terminals for initiating transactions. In such scenarios, acquirers currently fail to follow a unique standard procedure for assigning CAIDs to the merchants. As an example, in some scenarios, one CAID may be associated with one location of the merchant, e.g., all the remote terminals of the merchant configured in that location would be associated with the same CAID. In some other scenarios, each remote terminal of the merchant within a location may be associated with different CAIDs. In other scenarios, a cluster CAID would be assigned by the acquirer, e.g., each remote terminal configured in multiple locations of the merchant may be associated with a single CAID. In another scenario, one merchant store location may be associated with multiple merchant category codes and multiple CAIDs. Due to this non-standard procedure for assigning CAIDs, determining the origin of the merchant or identifying the merchant by analyzing the transaction data becomes extremely difficult and in majority of cases, impossible.

Further, when the respective acquirers install the remote terminals for the merchant, the merchants may fail to provide the Doing Business As (DBA) name or the registered name of the merchant uniformly, or in some cases, the acquirer may store the name of each branch differently for different branches. As an example, consider the DBA name of the merchant is “John's Coffee Day”. However, remote terminals of branch 1 may be installed with the name “JCD”, remote terminals of branch 2 may be installed with the name “J's coffee day” and “JC day”, remote terminals of branch 3 may be installed with the name “JCD coffee”, and the like. Therefore, such variations in the name of the merchant appearing in the transaction data makes it difficult to identify the merchant. In few other cases, at the time of installing the remote terminal, the merchant may provide an incorrect/partial address, which also does not support in identifying the merchant from the transaction data.

Due to the aforementioned glitches, currently, to identify the origin of the merchant, concerned organization performing data analytics of the transaction data may have to manually visit each merchant store and initiate a test transaction to understand the origin of the merchant. However, consider performing this act of visiting each merchant store in a country such as Australia, where one merchant may have more than 4000 active locations. In such scenarios, even if a person visits 5 locations in a day, he may need 800 days just to visit all the 4000 active locations of that merchant, and thereafter may require additional days to identify and distinguish transaction data related to those merchant locations from the transaction database. This is not just a tedious and extremely time-consuming process, but also a practically non-feasible option.

Therefore, currently, there exists a need for a correct, reliable, and feasible method to address one or more challenges described above.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

Additional features and advantages are realized through the techniques of the present disclosure. Other embodiments and aspects of the disclosure are described in detail herein and are considered a part of the claimed disclosure.

In some non-limiting embodiments or aspects, provided is a computer-implemented method comprising: in response to a test transaction initiated through a virtual card provided to a merchant, receiving, with at least one processor, test transaction data from an acquirer bank of the merchant, wherein the acquirer bank receives the test transaction data from a remote terminal of the merchant; detecting, in real-time and with at least one processor, a record of the test transaction in a transaction database associated with a card processing server using one or more attributes of the virtual card stored in the card processing server; in response to detecting the record of the test transaction, retrieving, with at least one processor, signature data from the test transaction data stored in the transaction database; and determining, with at least one processor, transaction source data of the merchant based on the signature data, wherein the transaction source data comprises location of the merchant at which the test transaction was initiated and a registered name of the merchant.

In some non-limiting embodiments or aspects, the test transaction data is received by the card processing server when the acquirer bank authorizes the test transaction initiated through the virtual card. In some non-limiting embodiments or aspects, the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof. In some non-limiting embodiments or aspects, the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof. In some non-limiting embodiments or aspects, the test transaction is initiated when the virtual card is communicatively interfaced with the remote terminal. In some non-limiting embodiments or aspects, determining the transaction source data and the registered name of the merchant comprises: comparing, with at least one processor, at least one of a merchant name of the signature data, a CAID of the merchant of the signature data, and a partial geolocation of the merchant of the signature data with transaction data stored in the transaction database; extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlating, with at least one processor, each of the extracted records of the one or more transactions and the signature data of the merchant to determine the transaction source data. In some non-limiting embodiments or aspects, the transaction data comprises the records of one or more transactions performed at one or more merchant locations of a plurality of merchants.

In some non-limiting embodiments or aspects, provided is a card processing server comprising: at least one processor; and a memory communicatively coupled to the at least one processor, wherein the memory stores processor-executable instructions, which, on execution, causes the at least one processor to: in response to a test transaction initiated through a virtual card provided to a merchant, receive test transaction data from an acquirer bank of the merchant, wherein the acquirer bank receives the test transaction data from a remote terminal of the merchant; detect, in real-time, a record of the test transaction in a transaction database associated with a card processing server using one or more attributes of the virtual card stored in the card processing server; in response to detecting the record of the test transaction, retrieve signature data from the test transaction data stored in the transaction database; and determine transaction source data of the merchant based on the signature data, wherein the transaction source data comprises location of the merchant at which the test transaction was initiated and a registered name of the merchant.

In some non-limiting embodiments or aspects, the test transaction data is received by the card processing server when the acquirer bank authorizes the test transaction initiated through the virtual card. In some non-limiting embodiments or aspects, the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof. In some non-limiting embodiments or aspects, the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof. In some non-limiting embodiments or aspects, the at least one processor initiates the test transaction when the virtual card is communicatively interfaced with the remote terminal. In some non-limiting embodiments or aspects, the at least one processor determines the transaction source data and the registered name of the merchant by: comparing, with at least one processor, at least one of a merchant name of the signature data, a CAID of the merchant of the signature data, and a partial geolocation of the merchant of the signature data with transaction data stored in the transaction database; extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlating, with at least one processor, each of the extracted records of the one or more transactions and the signature data of the merchant to determine the transaction source data. In some non-limiting embodiments or aspects, the transaction data comprises the records of one or more transactions performed at one or more merchant locations of a plurality of merchants.

In some non-limiting embodiments or aspects, provided is a non-transitory computer readable medium including instructions stored thereon that when processed by at least one processor causes a card processing server to perform operations comprising: in response to a test transaction initiated through a virtual card provided to a merchant, receiving, with at least one processor, test transaction data from an acquirer bank of a merchant, wherein the acquirer bank receives the test transaction data from a remote terminal of the merchant; detecting, in real-time and with at least one processor, a record of the test transaction in a transaction database associated with a card processing server using one or more attributes of the virtual card stored in the card processing server; in response to detecting the record of the test transaction, retrieving, with at least one processor, signature data from the test transaction data stored in the transaction database; and determining, with at least one processor, transaction source data of the merchant based on the signature data, wherein the transaction source data comprises location of the merchant at which the test transaction was initiated and a registered name of the merchant.

In some non-limiting embodiments or aspects, the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof. In some non-limiting embodiments or aspects, the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof. In some non-limiting embodiments or aspects, the test transaction is initiated when the virtual card is communicatively interfaced with the remote terminal. In some non-limiting embodiments or aspects, to determine the transaction source data and the registered name of the merchant, the instructions cause the at least one processor to: compare at least one of a merchant name of the signature data, a CAID of the merchant of the signature data, and a partial geolocation of the merchant of the signature data with the test transaction data stored in the transaction database; extract records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlate each of the extracted records of the one or more transactions and the signature data of the merchant to determine the transaction source data. In some non-limiting embodiments or aspects, the transaction data comprises the records of one or more transactions performed at one or more merchant locations of a plurality of merchants.

Further non-limiting embodiments or aspects are set forth in the following numbered clauses.

Clause 1: A computer-implemented method comprising: in response to a test transaction initiated through a virtual card provided to a merchant, receiving, with at least one processor, test transaction data from an acquirer bank of the merchant, wherein the acquirer bank receives the test transaction data from a remote terminal of the merchant; detecting, in real-time and with at least one processor, a record of the test transaction in a transaction database associated with a card processing server using one or more attributes of the virtual card stored in the card processing server; in response to detecting the record of the test transaction, retrieving, with at least one processor, signature data from the test transaction data stored in the transaction database; and determining, with at least one processor, transaction source data of the merchant based on the signature data, wherein the transaction source data comprises location of the merchant at which the test transaction was initiated and a registered name of the merchant.

Clause 2: The computer-implemented method of clause 1, wherein the test transaction data is received by the card processing server when the acquirer bank authorizes the test transaction initiated through the virtual card.

Clause 3: The computer-implemented method of clause 1 or 2, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

Clause 4: The computer-implemented method of any of clauses 1-3, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

Clause 5: The computer-implemented method of any of clauses 1-4, wherein the test transaction is initiated when the virtual card is communicatively interfaced with the remote terminal.

Clause 6: The computer-implemented method of any of clauses 1-5, wherein determining the transaction source data and the registered name of the merchant comprises: comparing, with at least one processor, at least one of a merchant name of the signature data, a CAID of the merchant of the signature data, and a partial geolocation of the merchant of the signature data with transaction data stored in the transaction database; extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlating, with at least one processor, each of the extracted records of the one or more transactions and the signature data of the merchant to determine the transaction source data.

Clause 7: The computer-implemented method of any of clauses 1-6, wherein the transaction data comprises the records of one or more transactions performed at one or more merchant locations of a plurality of merchants.

Clause 8: A card processing server comprising: at least one processor; and a memory communicatively coupled to the at least one processor, wherein the memory stores processor-executable instructions, which, on execution, causes the at least one processor to: in response to a test transaction initiated through a virtual card provided to a merchant, receive test transaction data from an acquirer bank of the merchant, wherein the acquirer bank receives the test transaction data from a remote terminal of the merchant; detect, in real-time, a record of the test transaction in a transaction database associated with a card processing server using one or more attributes of the virtual card stored in the card processing server; in response to detecting the record of the test transaction, retrieve signature data from the test transaction data stored in the transaction database; and determine transaction source data of the merchant based on the signature data, wherein the transaction source data comprises location of the merchant at which the test transaction was initiated and a registered name of the merchant.

Clause 9: The card processing server of clause 8, wherein the test transaction data is received by the card processing server when the acquirer bank authorizes the test transaction initiated through the virtual card.

Clause 10: The card processing server of clause 8 or 9, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

Clause 11: The card processing server of any of clauses 8-10, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

Clause 12: The card processing server of any of clauses 8-11, wherein the at least one processor initiates the test transaction when the virtual card is communicatively interfaced with the remote terminal.

Clause 13: The card processing server of any of clauses 8-12, wherein the at least one processor determines the transaction source data and the registered name of the merchant by: comparing, with at least one processor, at least one of a merchant name of the signature data, a CAID of the merchant of the signature data, and a partial geolocation of the merchant of the signature data with transaction data stored in the transaction database; extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlating, with at least one processor, each of the extracted records of the one or more transactions and the signature data of the merchant to determine the transaction source data.

Clause 14: The card processing server of any of clauses 8-13, wherein the transaction data comprises the records of one or more transactions performed at one or more merchant locations of a plurality of merchants.

Clause 15: A non-transitory computer readable medium including instructions stored thereon that when processed by at least one processor causes a card processing server to perform operations comprising: in response to a test transaction initiated through a virtual card provided to a merchant, receiving, with at least one processor, test transaction data from an acquirer bank of the merchant, wherein the acquirer bank receives the test transaction data from a remote terminal of the merchant; detecting, in real-time and with at least one processor, a record of the test transaction in a transaction database associated with a card processing server using one or more attributes of the virtual card stored in the card processing server; in response to detecting the record of the test transaction, retrieving, with at least one processor, signature data from the test transaction data stored in the transaction database; and determining, with at least one processor, transaction source data of the merchant based on the signature data, wherein the transaction source data comprises location of the merchant at which the test transaction was initiated and a registered name of the merchant.

Clause 16: The non-transitory computer readable medium of clause 15, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

Clause 17: The non-transitory computer readable medium of clause 15 or 16, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

Clause 18: The non-transitory computer readable medium of any of clauses 15-17, wherein the test transaction is initiated when the virtual card is communicatively interfaced with the remote terminal.

Clause 19: The non-transitory computer readable medium of any of clauses 15-18, wherein, to determine the transaction source data and the registered name of the merchant, the instructions cause the at least one processor to: compare at least one of a merchant name of the signature data, a CAID of the merchant of the signature data, and a partial geolocation of the merchant of the signature data with the test transaction data stored in the transaction database; extract records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and correlate each of the extracted records of the one or more transactions and the signature data of the merchant to determine the transaction source data.

Clause 20: The non-transitory computer readable medium of any of clauses 15-19, wherein the transaction data comprises the records of one or more transactions performed at one or more merchant locations of a plurality of merchants.

Disclosed herein is a computer-implemented method that may include receiving, by a card processing server, test transaction data from an acquirer bank of a merchant. The acquirer bank receives the test transaction data from a remote terminal of the merchant, in response to a test transaction initiated through a virtual card provided to the merchant. Further, the method includes detecting a record of the test transaction in a transaction database associated with a card processing server, in real-time, using one or more attributes of the virtual card stored in the card processing server. Subsequently, the method includes retrieving signature data from the test transaction data stored in the transaction database, upon detecting the record of the test transaction. Upon retrieving the signature data, the method includes extracting transaction source data of the merchant based on the signature data. The transaction source data comprises location of the merchant at which the test transaction was initiated and a registered name of the merchant.

Further, in some non-limiting embodiments or aspects, the present disclosure may include a card processing server. The card processing server includes a processor and a memory communicatively coupled to the processor. The memory stores the processor instructions, which, on execution, cause the processor to receive test transaction data from an acquirer bank of a merchant. The acquirer bank receives the test transaction data from a remote terminal of the merchant, in response to a test transaction initiated through a virtual card provided to the merchant. Further, the processor detects a record of the test transaction in a transaction database associated with a card processing server, in real-time, using one or more attributes of the virtual card stored in the card processing server. Subsequently, the processor retrieves signature data from the test transaction data stored in the transaction database, upon detecting the record of the test transaction. Upon retrieving the signature data, the processor extracts transaction source data of the merchant based on the signature data. The transaction source data comprises location of the merchant at which the test transaction was initiated and a registered name of the merchant.

Further, in some non-limiting embodiments or aspects, the present disclosure may include a non-transitory computer readable medium including instructions stored thereon that when processed by at least one processor causes a card processing server to perform operations comprising receiving test transaction data from an acquirer bank of a merchant. The acquirer bank receives the test transaction data from a remote terminal of the merchant, in response to a test transaction initiated through a virtual card provided to the merchant. Further, the instructions cause the processor to detect a record of the test transaction in a transaction database associated with a card processing server, in real-time, using one or more attributes of the virtual card stored in the card processing server. Subsequently, the instructions cause the processor to retrieve signature data from the test transaction data stored in the transaction database, upon detecting the record of the test transaction. Upon retrieving the signature data, the instructions cause the processor to extract transaction source data of the merchant based on the signature data. The transaction source data comprises location of the merchant at which the test transaction was initiated and a registered name of the merchant.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary system for determining a merchant location using a virtual card, in real-time, in accordance with some non-limiting embodiments or aspects of the present disclosure;

FIG. 2 shows a detailed block diagram of a card processing server for determining a merchant location using a virtual card, in real-time, in accordance with some non-limiting embodiments or aspects of the present disclosure;

FIG. 3 shows a flow chart illustrating method steps for determining a merchant location using a virtual card, in real-time, in accordance with some non-limiting embodiments or aspects of the present disclosure; and

FIG. 4 is a block diagram of an exemplary computer system for implementing non-limiting embodiments or aspects consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

In the following detailed description of the embodiments of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup, device, or method. In other words, one or more elements in a system or apparatus proceeded by “comprises . . . a” does not, without more constraints, preclude the existence of other elements or additional elements in the system or method.

The terms “includes”, “including”, or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The present disclosure relates to a computer implemented method, a card processing server, and a non-transitory computer readable medium for determining a merchant location using a virtual card, in real-time. The virtual card may be an electronic card or an online card, used for performing an online transaction, which is not issued physically. In some non-limiting embodiments or aspects, a merchant may be provided with the virtual card for performing a test transaction. Upon initiating a test transaction, using the virtual card, a card processing server may receive test transaction data from an acquirer bank of a merchant. Further, the card processing server may detect a record of the test transaction in a transaction database associated with the card processing server, in real-time, and thereafter may retrieve signature data from the test transaction data stored in the transaction database. Upon retrieving the signature data, the card processing server may extract transaction source data of the merchant based on the signature data. In some non-limiting embodiments or aspects, the transaction source data may include, but not be limited to, location of the merchant at which the test transaction was initiated and a registered name (which also may be referred to as Doing Business As (DBA) name) of the merchant.

The present disclosure issues a virtual card to the merchant, which can be used at each location of the merchant for initiating the test transaction. Therefore, this eliminates the need for a representative to physically visit each location of the merchant to perform a transaction. Upon initiating the test transaction using the virtual card, since one or more attributes associated with the virtual card are already known to the card processing server, the card processing server detects a record of the test transaction in the transaction database and extracts the signature data from the test transaction data, in real-time. This enables the card processing server to compare and correlate the signature data with transaction data in the database to determine the transaction source data, in real-time. Therefore, the present disclosure enables time-effective, reliable, and a dynamic determination of the transaction source data of the merchant, without the hassle of physically visiting each store, which in turn helps in achieving effective and accurate data analytics for various applications as discussed in the background section.

In the following detailed description of the non-limiting embodiments or aspects of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

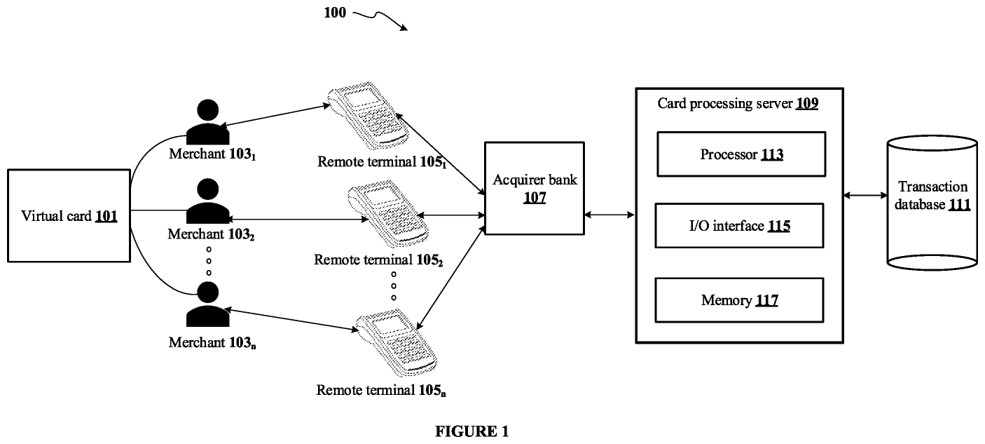

FIG. 1 shows an exemplary system 100 for determining a merchant location using a virtual card, in real-time, in accordance with some non-limiting embodiments or aspects of the present disclosure. In one implementation, the system 100 may include a virtual card 101, one or more merchants 103₁ to 103ₙ (collectively referred to as one or more merchants 103 or merchants 103), one or more remote terminals 105₁ to 105ₙ (collectively referred to as one or more remote terminals 105 or remote terminals 105), an acquirer bank 107, a card processing server 109, and a transaction database 111. In some non-limiting embodiments or aspects, the virtual card 101 may be treated as a test card provided to the merchant 103 for performing a test transaction. In some non-limiting embodiments or aspects, one virtual card 101 may be issued and the same virtual card 101 may be provided for all the merchants 103 whose store locations need to be detected.

In some non-limiting embodiments or aspects, a unique virtual card 101 may be issued and provided for each merchant 103. In some non-limiting embodiments or aspects, the merchant 103 may initiate the test transaction by communicatively interfacing the virtual card 101 with the remote terminal 105. As an example, the remote terminal 105 may be a Point of Sale (PoS) device, such as a card accepting device that initiates a transaction. As an example, the virtual card 101 may be interfaced by means of contactless interfacing, such as positioning the virtual card 101 proximal to the remote terminal 105, such as by tapping, scanning a code (e.g., as barcode or QR code on the virtual card 101), and the like. As an example, technologies, such as Near Field Communication (NFC), Magnetic Secure Transmission (MST), and the like, may be used for interfacing the virtual card 101 with the remote terminal 105.

In one exemplary scenario, where a merchant store comprises five remote terminals 105₁ to 105₅, the merchant 103 may initiate the test transaction at each of the five remote terminals 105₁ to 105₅ using the virtual card 101, which helps in uniquely identifying each of the five remote terminals 105₁ to 105₅. In some non-limiting embodiments or aspects, the merchant 103 may initiate the transaction at one of the five remote terminals 105₁ and the remainder of the remote terminals 105₂ to 105₄ may be mapped based on test transaction data of that one remote terminal 105₁, at the backend. Therefore, if the merchant has multiple branches at different merchant locations and multiple remote terminals 105 at each branch, then the merchant 103 should initiate the test transaction from at least one remote terminal 105 at each merchant location, using the virtual card 101.

Upon initiating the test transaction using the virtual card 101, the card processing server 109 may receive test transaction data from the acquirer bank 107 of the merchant 103. In some non-limiting embodiments or aspects, the acquirer bank 107 may be the same as an issuing bank. In some non-limiting embodiments or aspects, the card processing server 109 may receive the test transaction data when the acquirer bank 107 authorizes the test transaction initiated through the virtual card 101. In some non-limiting embodiments or aspects, the remote terminal 105, the acquirer bank 107, and the card processing server 109 may be associated with each other via a communication network. In some non-limiting embodiments or aspects, the communication network may be a wireless communication network.

The card processing server 109 may include a processor 113, an Input/Output (I/O) interface 115, and a memory 117. The I/O interface 115 may enable receiving the test transaction data from the acquirer bank 107. The test transaction data may be stored in the transaction database 111 associated with the card processing server 109. The transaction database 111 comprises transaction data, such as records of one or more transactions performed at one or more merchant locations of plurality of merchants. The transaction data is dynamically updated in the transaction database 111 as and when a transaction is processed.

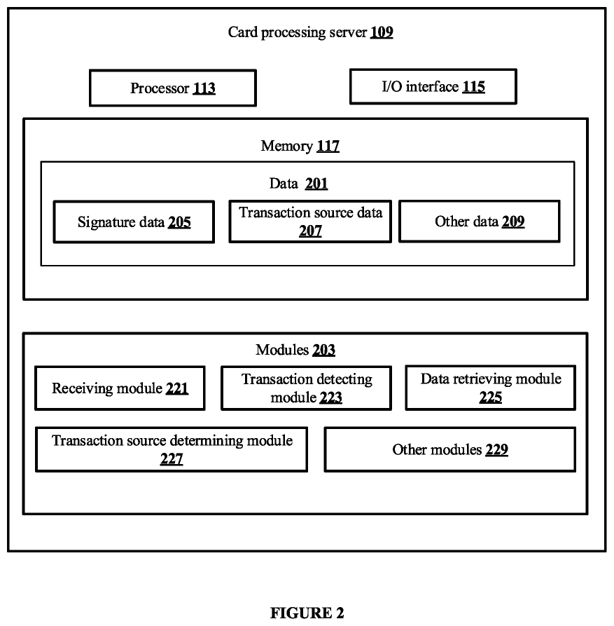

In some implementations, the card processing server 109 may include data 201 and modules 203 as shown in FIG. 2. As an example, the data 201 may be stored in the memory 117. In some non-limiting embodiments or aspects, the data 201 may include signature data 205, transaction source data 207, and other data 209. In the illustrated FIG. 2, modules 203 are described herein in detail. In some non-limiting embodiments or aspects, the data 201 may be stored in the memory 117 in form of various data structures. Additionally, the data 201 can be organized using data models, such as relational or hierarchical data models. The other data 209 may store data, including temporary data and temporary files, generated by the modules 203 for performing the various functions of the card processing server 109.

In some non-limiting embodiments or aspects, the data 201 stored in the memory 117 may be processed by the modules 203 of the card processing server 109. The modules 203 may be stored within the memory 117. In an example, the modules 203 communicatively coupled to the processor 113 configured in the card processing server 109 may also be present outside the memory 117, as shown in FIG. 2, and implemented as hardware. As used herein, the term modules 203 may refer to an application specific integrated circuit (ASIC), an electronic circuit, a processor (shared, dedicated, and/or group) and memory that execute one or more software or firmware programs, a combinational logic circuit, and/or other suitable components that provide the described functionality.

In some non-limiting embodiments or aspects, the modules 203 may include, for example, a receiving module 221, a transaction detecting module 223, a data retrieving module 225, a transaction source determining module 227, and other modules 229. The other modules 229 may be used to perform various miscellaneous functionalities of the card processing server 109. It will be appreciated that such aforementioned modules 203 may be represented as a single module or a combination of different modules.

In some non-limiting embodiments or aspects, the receiving module 221 may receive the test transaction data from the acquirer bank 107 in response to the test transaction initiated through the virtual card 101 provided to the merchant 103. As an example, the test transaction data may include, but is not limited to, one or more of the following: virtual card data, a Bank Identification Number (BIN), a Card Acceptor Identifier (CAID) of the merchant 103, a merchant name, a Merchant Category Code (MCC), a Primary Account Number (PAN) of the transaction, a partial geolocation of the merchant 103, a merchant ID, a store ID of the merchant 103, transaction amount, date of transaction, an authentication code, or any combination thereof. As an example, the virtual card data may include one or more attributes of the virtual card 101. As an example, the one or more attributes of the virtual card 101 may include, but is not limited to, one or more of the following: a virtual card number, a name of cardholder, a name of the merchant for whom the virtual card 101 is issued, a virtual card verification value, an expiration date of the virtual card 101, a purpose of the virtual card 101, a name of the issuer of the virtual card 101, and the like.

In some non-limiting embodiments or aspects, the transaction detecting module 223 may detect a record of the test transaction in the transaction database 111, in real-time, using the one or more attributes of the virtual card 101 stored in the card processing server 109. As an example, the transaction detecting module 223 may map the one or more attributes of the virtual card 101 stored in the card processing server 109 with the test transaction data to detect a match.

In some non-limiting embodiments or aspects, upon detecting the record of the test transaction in the transaction database 111, the data retrieving module 225 may retrieve signature data 205 from the test transaction data. In some non-limiting embodiments or aspects, the signature data 205 may include, but is not limited to, one or more of the following: the virtual card data, the BIN, the CAID of the merchant 103, the merchant name, the MCC, the PAN of the transaction, the partial geolocation of the merchant 103, the merchant ID, the store ID of the merchant 103, transaction amount, date of transaction, the authentication code, and the like. The partial geolocation of the merchant 103 may include details such as city, PIN code, street name, and the like, which were initially provided by the merchant 103 at the time of installation of the respective remote terminal 105.

In some non-limiting embodiments or aspects, upon retrieving the signature data 205, the transaction source determining module 227 may extract transaction source data 207 of the merchant 103 based on the signature data 205. The transaction source data 207 may include, but is not limited to, location (roof-top or physical location) of the merchant 103 at which the test transaction was initiated and the registered name of the merchant 103. Initially, the transaction source determining module 227 may compare at least one of the merchant name, the CAID of the merchant 103, and the partial geolocation of the merchant 103, of the signature data 205, with the transaction data stored in the transaction database 111. Based on the comparison, the transaction source determining module 227 extracts records of one or more transactions from the transaction data based on the comparison. In some non-limiting embodiments or aspects, the extracted records of the one or more transactions are one of a complete match or a partial match to at least one of the merchant name, the CAID of the merchant, and the partial geolocation of the merchant used for the comparison.

As an example, consider a possibility where the merchant name and the CAID of the merchant 103 are used for comparison. In this possibility, the merchant name and the CAID of the merchant 103 extracted from the signature data 205 may be compared with each merchant name and corresponding CAID in the transaction data to identify at least one of a partial match or a complete match. Based on the comparison, the extracted records may be, for example, records having matching CAID and matching merchant name, records having matching CAID but different merchant name, records having matching merchant name but different CAID, records having partial matching CAID and partial matching merchant name, records having matching CAID but partially matching merchant name, and the like.

As an example, consider a possibility where only the merchant name is used for comparison. In this possibility, the merchant name of the merchant 103 extracted from the signature data 205 may be compared with each merchant name in the transaction data to identify at least one of a partial match or a complete match. In some non-limiting embodiments or aspects, a fuzzy logic technique may be used to identify the partial match or the complete match based on the merchant name. As a result, the extracted records may be, for example, records having completely matching merchant name and records having partially matching merchant name.

As an example, consider another possibility where the merchant name and the partial geolocation of the merchant 103 are used for comparison. In this example, the merchant name and the partial geolocation of the merchant 103 extracted from the signature data 205 may be compared with each merchant name and corresponding geolocation in the transaction data to identify at least one of a partial match or a complete match. Based on the comparison, the extracted records may be, for example, records having matching geolocation and matching merchant name, records having matching geolocation but different merchant name, records having matching merchant name but different geolocation, records having partial matching geolocation and partial matching merchant name, records having matching geolocation but partially matching merchant name, and the like.

In some non-limiting embodiments or aspects, the combinations and possibilities of at least one of the merchant name, the CAID of the merchant 103, and the partial geolocation of the merchant 103 mentioned above should not be construed as a limitation of the present disclosure, as the present disclosure is applicable for the combinations and possibilities apart from those mentioned above. However, in some non-limiting embodiments or aspects, the comparison with the CAID of the merchant 103 and the merchant name may be given the highest priority.

Further, the transaction source determining module 227 may correlate each of the extracted records of the one or more transactions and the signature data 205 of the merchant 103 to determine the transaction source data 207. The process of determining the transaction source data 207 is explained below with the help of an exemplary scenario. However, this should not be construed as a limitation of the present disclosure.

As an example, consider a merchant 103 taps the virtual card 101 on one of the remote terminals 105 at a given merchant location. Exemplary test transaction data received by the card processing server 109 and the signature data 205 retrieved from the test transaction data is as shown in the below Table 1.

TABLE 1

| Input_merchant name | Input_CAID | Input_address | Input_MCC |
|---|---|---|---|
| John's Coffee Day | 12345 | Vivo city 56043 | 342 |

As an example, consider a scenario where the card processing server 109 uses both the merchant name and the CAID of the merchant 103 for performing the comparison. Therefore, the card processing server 109 would search for records of one or more transactions from the transaction database 111, which match completely or partially, to at least one of the merchant name or the CAID. The records of one or more transactions extracted based on the comparison are as shown below in Table 2.

TABLE 2

| | | Authentica- | | Clearance |
|---|---|---|---|---|
| Sl. no | Merchant name | tion CAID | Address | CAID |
| 1 | JCD | 12345 | 1, Harbourfront, | 00012345 |
| | | | walk vivo city | |
| | | | 56043 | |
| 2 | John's Coffee | 12345 | Vivo city 56043 | 00012345 |
| | Day | | | |
| 3 | JCday | 12356 | Vivo city 56043 | 0012356 |
| 4 | J's Coffee Day | 12356 | Vivo city 56043 | 0012356 |

In the above Table 2, the CAID of the merchant “JCD” matches with the CAID of the merchant “John's Coffee Day”, though names of the merchants do not match. Further, when the address of the merchant “JCD” is compared with the address of the merchant “John's Coffee Day”, part of the address “Vivo city 56043” of the merchant “John's Coffee Day” matches partially with the address of the merchant “JCD”. Therefore, the card processing server 109 correlates the CAID and the address of the merchant 103 and the merchant in Row 1, and determines that the registered name of the merchant 103 is “John's Coffee Day”, and the location of the merchant 103 is “1, Harbourfront, walk vivo city 56043”.

Further, when the card processing server 109 compares the CAID and location of the merchant 103 with the CAID and location of the merchants in Table 2, the card processing server 109 may identify that the CAID of merchants “JCday” and “J's Coffee Day” is the same, the CAID of merchants “JCD” and “John's Coffee Day” is the same, and the address of each of these merchants results in a partial match with the location of the merchant 103. The card processing server 109 may correlate this information to arrive at an inference that the registered name of each of these merchants is “John's Coffee Day” and each transaction record belongs to the same merchant location “1, Harbourfront, walk vivo city 56043”. Further, in this example, there are four remote terminals 105 in this merchant location among which two remote terminals are associated with the CAID “12345” and two other remote terminals are associated with the CAID “12356”. Thereafter, the card processing server 109 may consider any future transaction with the merchant name “JCD”, “JCDay”, “J's Coffee Day”, and other variations as “John's Coffee Day”, which in turn helps in performing accurate analytics.

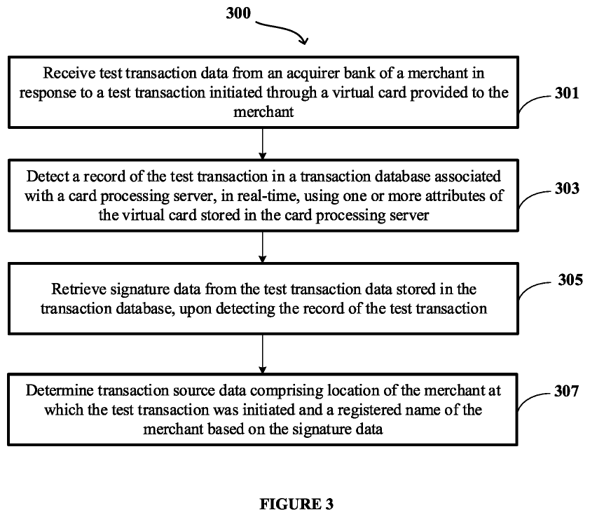

FIG. 3 shows a flow chart illustrating a method 300 of determining a merchant location using a virtual card, in real-time, in accordance with some non-limiting embodiments or aspects of the present disclosure. The order in which the method 300 is described is not intended to be construed as a limitation, and any number of the described method blocks can be combined in any order to implement the method 300. Additionally, individual blocks may be deleted from the methods without departing from the spirit and scope of the subject matter described herein. Furthermore, the method 300 can be implemented in any suitable hardware, software, firmware, or combination thereof.

At block 301, the method 300 may include receiving, by a processor 113 of a card processing server 109, test transaction data from an acquirer bank 107 of a merchant 103. In some non-limiting embodiments or aspects, the acquirer bank 107 may receive the test transaction data from a remote terminal 105 of the merchant, in response to a test transaction initiated through a virtual card 101 provided to the merchant 103.

At block 303, the method 300 may include detecting, by the processor 113, a record of the test transaction in a transaction database 111 associated with a card processing server 109, in real-time, using one or more attributes of the virtual card 101 stored in the card processing server 109.

At block 305, the method 300 may include retrieving, by the processor 113, signature data 205 from the test transaction data stored in the transaction database 111 upon detecting the record of the test transaction.

At block 307, the method 300 may include determining, by the processor 113, transaction source data 207 of the merchant based on the signature data. The transaction source data 207 comprises location of the merchant 103 at which the test transaction was initiated and a registered name of the merchant 103. In some non-limiting embodiments or aspects, the processor 113 may determine the transaction source data 207 by comparing at least one of the CAID of the merchant 103, partial geolocation of the merchant 103, and merchant name with transaction data stored in the transaction database 111 and extracting records of one or more transactions that result in one of a complete match or a partial match based on this comparison. The extracted records of the one or more transactions may be further correlated with the signature data 205 to determine the transaction source data 207.

The present disclosure eliminates the need for a representative to physically visit each location of the merchant 103 to perform a test transaction by issuing a virtual card 101 for each merchant. Upon initiating the test transaction using the virtual card 101, since one or more attributes associated with the virtual card 101 are already known to the card processing server 109, the card processing server 109 detects a record of the test transaction in the transaction database 111 and extracts the signature data 205 from the test transaction data, in real-time. This enables the card processing server 109 to compare and correlate the signature data 205 with transaction data in the transaction database 111 to determine the transaction source data, in real-time. Therefore, the present disclosure enables time-effective, reliable, and dynamic determination of the transaction source data of the merchant 103 without the hassle of visiting each store physically. This, in turn, helps in achieving effective and accurate data analytics for various applications, such as peer detection, setting up loyalty offers and discounts, detection of fraud merchants, MCC fee compliance, transaction related dispute management, and the like.

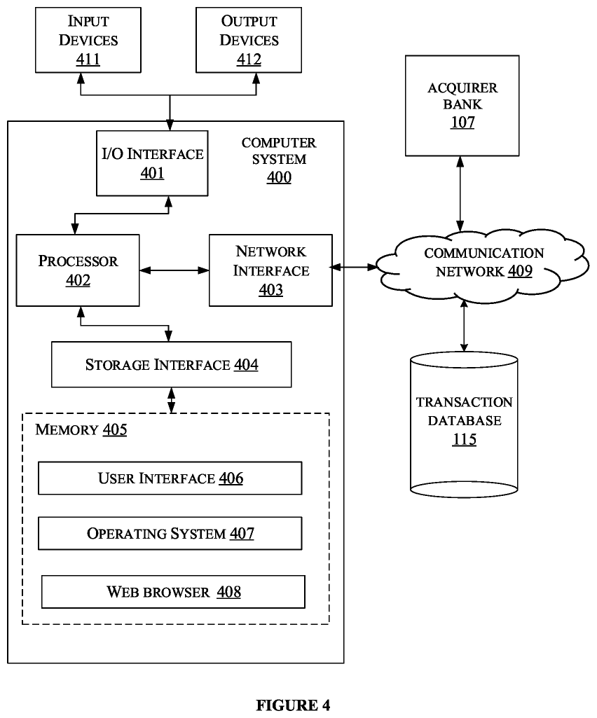

FIG. 4 illustrates a block diagram of an exemplary computer system 400 for implementing non-limiting embodiments or aspects consistent with the present disclosure. In some non-limiting embodiments or aspects, the computer system 400 can be card processing server 109 that is used for determining a merchant location using a virtual card 101, in real-time. The computer system 400 may include a central processing unit (“CPU” or “processor”) 402. The processor 402 may include at least one data processor for executing program components for executing user- or system-generated business processes. A user may include a person, a person using a device such as those included in this disclosure, or such a device itself. The processor 402 may include specialized processing units such as integrated system (bus) controllers, memory management control units, floating point units, graphics processing units, digital signal processing units, etc.

The processor 402 may be disposed in communication with input devices 411 and output devices 412 via an I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax®, or the like), etc.

Using the I/O interface 401, the computer system 400 may communicate with the input devices 411 and the output devices 412.

In some non-limiting embodiments or aspects, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the computer system 400 may communicate with a transaction database 115 and an acquire bank 107. In some non-limiting embodiments or aspects, the computer system 400 is capable of communicating with plurality of remote terminals 105₁ to 105ₙ in parallel. The communication network 409 can be implemented as one of the different types of networks, such as intranet or Local Area Network (LAN), Closed Area Network (CAN), and such. The communication network 409 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. In some non-limiting embodiments or aspects, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408, etc. In some non-limiting embodiments or aspects, the computer system 400 may store user/application data, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLE™ ANDROID™, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some non-limiting embodiments or aspects, the computer system 400 may implement the web browser 408 stored program components. The web browser 408 may be a hypertext viewing application, such as MICROSOFT® INTERNET EXPLORER®, GOOGLE® CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 408 may utilize facilities such as AJAX, DHTML, ADOBE® FLASH®, JAVASCRIPT®, JAVA®, Application Programming Interfaces (APIs), etc. In some non-limiting embodiments or aspects, the computer system 400 may implement a mail server stored program component. The mail server may be an Internet mail server such as MICROSOFT® Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some non-limiting embodiments or aspects, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some non-limiting embodiments or aspects”, and “one embodiment” mean “one or more (but not all) embodiments of the invention(s)” unless expressly specified otherwise.

A description of an embodiment with several components in communication with each other does not imply that all such components are required. On the contrary, a variety of optional components is described to illustrate the wide variety of possible embodiments of the disclosure.

The terms “including”, “comprising”, “having”, and variations thereof mean “including but not limited to” unless expressly specified otherwise. The enumerated listing of items does not imply that any or all of the items are mutually exclusive unless expressly specified otherwise. The terms “a”, “an”, and “the” mean “one or more” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

The illustrated operations of FIG. 3 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A computer-implemented method comprising:
in response to a test transaction initiated through a virtual card provided to a merchant, receiving, with at least one processor, test transaction data from an acquirer bank of the merchant, wherein the acquirer bank receives the test transaction data from a remote terminal of the merchant;
detecting, in real-time and with at least one processor, a record of the test transaction in a transaction database associated with a card processing server using one or more attributes of the virtual card stored in the card processing server;
in response to detecting the record of the test transaction, retrieving, with at least one processor, signature data from the test transaction data stored in the transaction database; and
determining, with at least one processor, transaction source data of the merchant based on the signature data, wherein the transaction source data comprises location of the merchant at which the test transaction was initiated and a registered name of the merchant.

2. The computer-implemented method of claim 1, wherein the test transaction data is received by the card processing server when the acquirer bank authorizes the test transaction initiated through the virtual card.

3. The computer-implemented method of claim 1, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

4. The computer-implemented method of claim 3, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

5. The computer-implemented method of claim 1, wherein the test transaction is initiated when the virtual card is communicatively interfaced with the remote terminal.

6. The computer-implemented method of claim 1, wherein determining the transaction source data and the registered name of the merchant comprises:
comparing, with at least one processor, at least one of a merchant name of the signature data, a CAID of the merchant of the signature data, and a partial geolocation of the merchant of the signature data with transaction data stored in the transaction database;
extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and
correlating, with at least one processor, each of the extracted records of the one or more transactions and the signature data of the merchant to determine the transaction source data.

7. The computer-implemented method of claim 6, wherein the transaction data comprises the records of one or more transactions performed at one or more merchant locations of a plurality of merchants.

8. A card processing server comprising:
at least one processor; and
a memory communicatively coupled to the at least one processor, wherein the memory stores processor-executable instructions, which, on execution, causes the at least one processor to:
in response to a test transaction initiated through a virtual card provided to a merchant, receive test transaction data from an acquirer bank of the merchant, wherein the acquirer bank receives the test transaction data from a remote terminal of the merchant;
detect, in real-time, a record of the test transaction in a transaction database associated with a card processing server using one or more attributes of the virtual card stored in the card processing server;
in response to detecting the record of the test transaction, retrieve signature data from the test transaction data stored in the transaction database; and
determine transaction source data of the merchant based on the signature data, wherein the transaction source data comprises location of the merchant at which the test transaction was initiated and a registered name of the merchant.

9. The card processing server of claim 8, wherein the test transaction data is received by the card processing server when the acquirer bank authorizes the test transaction initiated through the virtual card.

10. The card processing server of claim 8, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

11. The card processing server of claim 10, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

12. The card processing server of claim 8, wherein the at least one processor initiates the test transaction when the virtual card is communicatively interfaced with the remote terminal.

13. The card processing server of claim 8, wherein the at least one processor determines the transaction source data and the registered name of the merchant by:
comparing, with at least one processor, at least one of a merchant name of the signature data, a CAID of the merchant of the signature data, and a partial geolocation of the merchant of the signature data with transaction data stored in the transaction database;
extracting, with at least one processor, records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and
correlating, with at least one processor, each of the extracted records of the one or more transactions and the signature data of the merchant to determine the transaction source data.

14. The card processing server of claim 13, wherein the transaction data comprises the records of one or more transactions performed at one or more merchant locations of a plurality of merchants.

15. A non-transitory computer readable medium including instructions stored thereon that when processed by at least one processor causes a card processing server to perform operations comprising:
in response to a test transaction initiated through a virtual card provided to a merchant, receiving, with at least one processor, test transaction data from an acquirer bank of the merchant, wherein the acquirer bank receives the test transaction data from a remote terminal of the merchant;
detecting, in real-time and with at least one processor, a record of the test transaction in a transaction database associated with a card processing server using one or more attributes of the virtual card stored in the card processing server;
in response to detecting the record of the test transaction, retrieving, with at least one processor, signature data from the test transaction data stored in the transaction database; and
determining, with at least one processor, transaction source data of the merchant based on the signature data, wherein the transaction source data comprises location of the merchant at which the test transaction was initiated and a registered name of the merchant.

16. The non-transitory computer readable medium of claim 15, wherein the test transaction data and the signature data comprise at least one of the following: virtual card data, a Bank Identification Number (BIN), a Card Acceptor Identifier (CAID) of the merchant, a merchant name, a Merchant Category Code (MCC), a Primary Account Number (PAN) used in the test transaction, a partial geolocation of the merchant, a merchant ID, a store ID of the merchant, transaction amount, date of transaction, an authentication code, or any combination thereof.

17. The non-transitory computer readable medium of claim 16, wherein the virtual card data comprises one or more attributes of the virtual card, wherein the one or more attributes comprise at least one of the following: a virtual card number, a name of a cardholder, a virtual card verification value, an expiration date of the virtual card, a purpose of the virtual card, or any combination thereof.

18. The non-transitory computer readable medium of claim 15, wherein the test transaction is initiated when the virtual card is communicatively interfaced with the remote terminal.

19. The non-transitory computer readable medium of claim 15, wherein, to determine the transaction source data and the registered name of the merchant, the instructions cause the at least one processor to:
compare at least one of a merchant name of the signature data, a CAID of the merchant of the signature data, and a partial geolocation of the merchant of the signature data with the test transaction data stored in the transaction database;
extract records of one or more transactions from the transaction data based on the comparison, wherein the extracted records of the one or more transactions are a complete match or a partial match to at least one of the merchant name of the signature data, the CAID of the merchant of the signature data, and the partial geolocation of the merchant of the signature data, used for the comparison; and
correlate each of the extracted records of the one or more transactions and the signature data of the merchant to determine the transaction source data.

20. The non-transitory computer readable medium of claim 19, wherein the transaction data comprises the records of one or more transactions performed at one or more merchant locations of a plurality of merchants.
